(19) United States
(12) Patent Application Publication
(10) Pub. No.: US 2012/0226753 A1
(43) Pub. Date: Sep. 6, 2012

(54) Method and System for Intelligent Creation of Agenda Events

(75) Inventors: Ping Cheng, (US); Yu Lin, Beijing (CN); Shihong Zou, Beijing (CN)

(73) Assignee: Beijing NetQin Technology Co., LTD., Beijing (CN)

(21) Appl. No.: 13/412,241

(22) Filed: Mar. 5, 2012

(30) Foreign Application Priority Data
Mar. 4, 2011 (CN) 201110053423.6

(51) Int. Cl. G06F 15/16

(52) U.S. Cl. 709/204

(57) ABSTRACT

Methods and systems for intelligently creating agenda events are disclosed. A method includes receiving a message, analyzing the received message, determining whether the received message is an agenda-type message based on a data format of the received message, and if it is determined as an agenda-type message, creating a first new agenda event. The method further includes determining message type based on a semantic analysis of the received message, and if it is determined as an agenda-type message, creating a second new agenda event. The method and the system for intelligently creating of agenda events create agenda events automatically, based on the characteristics of the received messages, thereby improving the efficiency of the agenda.

### FIELD OF THE INVENTION

The present disclosure generally relates to software applications for mobile communications and computers and, more particularly, to methods and systems for creating agenda events.

### BACKGROUND

Existing techniques for creating agenda events normally require users to enter information of every event manually. This is a time-consuming process, and tends to frustrate people and make people lose interest in creating agenda events. Without proper agenda, normal life activities will be in less control and discipline, thereby degrading the quality of life.

### SUMMARY

In view of the aforementioned disadvantages of existing techniques, the present disclosure provides methods and systems for intelligent creation of agenda events. The methods and systems create agenda events automatically upon monitoring and analyzing received messages or content of received files, and classifying the agenda events.

According to one aspect of the disclosure, a method for intelligently creating of agenda events includes receiving message, analyzing the received message, determining whether the received message is an agenda-type message based on a data format of the message, and if it is determined as an agenda-type message, creating a first new agenda event. Optionally, the data format of the received message is predetermined and agreed by both a message sender and a message receiver.

If the received message is determined not as an agenda-type message based on the data format, the method optionally includes determining whether the received message is an agenda-type message based on a semantic analysis, and if it is determined as an agenda-type message, creating a second new agenda event.

Optionally, the data format for determining a message type is predetermined and accepted by both a message receiver and a message sender; the semantic analysis includes analyzing information of the received message as to time, location, participants, activity, or combinations thereof.

According to another aspect of the disclosure, a method for intelligently creating agenda events includes receiving a message, analyzing the received message; determining whether the received message is an agenda-type message based on a semantic analysis, and if the received message is determined as an agenda-type message, creating a first new agenda event.

If the received message is determined not as an agenda-type message based on the semantic analysis, the method optionally includes determining whether the received message is an agenda-type message based on a data format of the received message; and if the received message is determined as an agenda-type message, creating a second new agenda event.

Optionally, the data format is predetermined and agreed by both a message sender and a message receiver; and the semantic analysis includes analyzing information of the received message as to time, location, participants, activity, or combinations thereof.

According to another aspect of the present disclosure, a method for intelligently creating of agenda events includes sending a message by a message sending module of a sending client end to a receiving client end, receiving the message by a message receiving/sending module of the receiving client end, and forwarding the message to a message analysis module for message analyzing, if the message is determined to be an agenda-type message based on a data format of the message, storing the message in an agenda management module, if the message is determined not as an agenda-type message, further determining the message based on a semantic analysis, and if the message is determined as an agenda-type message based on the semantic analysis, storing the message in the agenda management module.

According to another aspect of the disclosure, a system for intelligently creating agenda events includes a sending client end and a receiving client end, wherein the sending client end includes at least a message sending module, wherein the receiving client end includes at least a first message receiving/sending module, a first message analysis module, and a first agenda event management module, and wherein the first message receiving/sending module is configured to receive/send messages, the first message analysis module is configured to analyze the received message, and the first agenda event management module is configured to store and process the message if the received message is determined as an agenda-type event.

Optionally, the sending client end further includes a second message receiving module, a second message analysis module, and a second agenda event management module. Optionally, the sending client end and the receiving client end are communication terminals having capability of communicating with one another at least.

The method and system for intelligent creation of agenda events is based on the characteristics of messages. Such creation is performed automatically, thereby improving the efficiency of agenda.

The aforementioned characteristics and advantages of the present disclosure will be more apparent in view of the following drawing and detailed description that are incorporated herewith. The drawings and the detailed description are presented to specify the principle of the disclosure.

### BRIEF DESCRIPTION OF THE DRAWINGS

FIG. 1 is a schematic illustration of a system for the intelligent creation of agenda events according to an embodiment of the invention;

FIG. 2 is a flow diagram describing a process for the intelligent creation of agenda events according to an embodiment of the invention;

FIG. 3 is an illustration of the data format of a message according to an embodiment of the invention; and

FIG. 4 is an illustration of a system for the intelligent creation of agenda event according to an embodiment of the invention.

### DETAILED DESCRIPTION

The embodiments are described hereinafter with reference to the accompanying drawings. In the description below, a large amount of details are described for better understanding. However, those skilled in the art will appreciate that the present invention is not limited to these details.

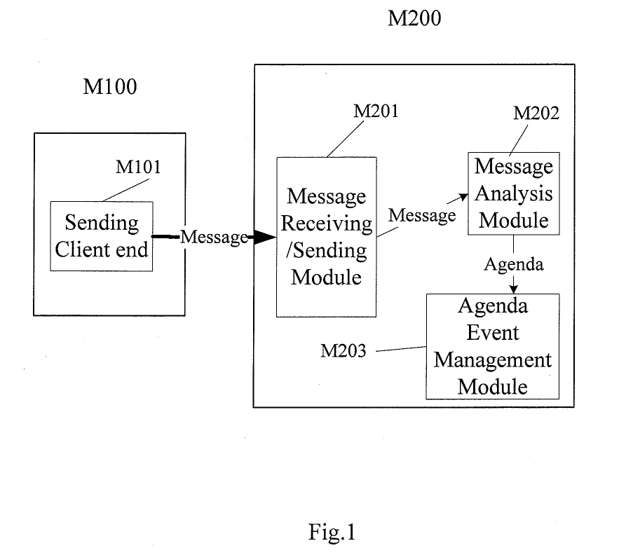

Referring to FIG. 1, a system for intelligent creation of agenda events according to an embodiment of the invention is now described. A system for intelligent creation of agenda events can include a sending client end M100 and a receiving client end M200. The sending client end M100 can include at least a message sending module M101. The receiving client end M200 can include at least a message receiving/sending module M201, a message analysis module M202, and an agenda event management module M203. The message receiving/sending module M201 can be configured to receive/send messages. The message analysis module M202 can be configured to analyze one or more received messages and, if a received message is determined to be an agenda-type message, store the message in the agenda event management module M203 as a record for further processing. Optionally, the sending client end M100 can have the same configuration as the receiving client end M200: the sending client end M100 can include at least a message receiving module, a message analysis module, and an agenda event management module. Optionally, the receiving client end M200 can be used as a sending client end, because the receiving client end M200 can also include a message receiving/sending module M201.

The sending client end M100 and the receiving client end M200 can communicate through a cable connection or wireless communication. The message can be selected from, for example, a short message, multimedia message, or data file.

According to one embodiment, a method for intelligent creation of agenda events based on semantic analysis and/or data format analysis is provided. The message sending module M101 of the sending client end M100 can send a message to the receiving client end M200. The message receiving/sending module M201 of the receiving client end M200 can receive the message from the sending client end M100, forward the message to the message analysis module M202 for data analysis. If the message is determined to be an agenda-type message based on the data format of the message, the message is stored in the agenda event management module M203; if the message is determined not to be an agenda-type message, the type of the message is further determined based on a semantic analysis. If the message is determined as an agenda-type message based on the semantic analysis, the message is stored in the agenda event management module 203; if not, the message is forwarded to other data management module. For example, if a short message or a multimedia message is received, the message is forwarded to the inbox of the mobile phone and displayed.

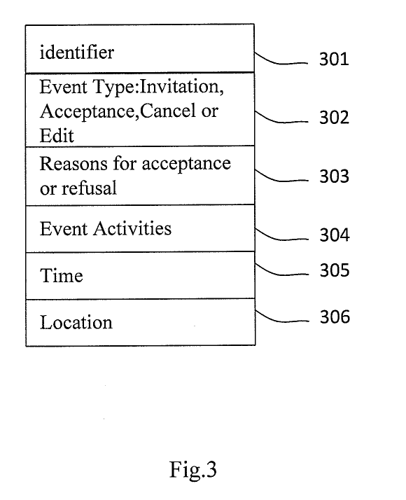

Optionally, the message type can be determined based on the data format of the message because the message may for example include a particular identifier of the agenda-type message, a hyperlink to a webpage for downloading the agenda event management module M203, or a particular alignment manner of certain characters in the message. The data format of an agenda-type message according to an embodiment is illustrated in FIG. 3. The message can contain an identifier 301, an event type 302 (e.g., accepted, canceled or amended), reasons for acceptance or refusal 303, event activities 304, time 305, and location 306.

Optionally, the sending client end M100 and the receiving client end M200 can be terminals with communication capabilities (e.g., cell phone, PDA, or PC).

Optionally, the message analysis module M202 can be an automatic process running on the receiving client end M200 and continuing monitoring received messages. The agenda event management module M203 can launch in response to the output of the message analysis module M202, when the received message is determined as an agenda-type message. Optionally, the system of the present disclosure can support importing of multiple agenda events.

The aforementioned data format can be a predetermined data format agreed by both client ends. For example:
Activity: Alumni Potluck
Time: Dec. 12, 2010, 19:00
Location: Huadu Teppan Yaki at Chaoyangmen Street.
Participants: ZHANG, San; LI, Si, WANG, Wu; ZHAO, Liu.

A message having the above-mentioned format and content can be determined as a new agenda event and saved automatically. The above-mentioned format and content is only an example. Persons of ordinary skill in the art would appreciate, however, that the present invention is not restricted to any particular message formats and contents.

The semantic analysis can be based on the meaning of the content included in a message, and agenda events can be recognized automatically by this analysis. For example, if a semantic analysis indicates that a message includes information relating to time, location, participants, activity, or a combination thereof, such message can be stored as a new agenda event or a notice informing the user about the new agenda event and requiring confirmation. If the user confirms, a new agenda event will be created and stored. Nevertheless, the semantic analysis is not limit to the afore-mentioned semantic factors; other event related information can be identified to recognize the agenda events. For example, if a receiver receives a message “Friday, 19:00, Qiangui Karaoke, all you guys”, the receiving client end can recognize typical content, such as time and location, etc. An agenda event can be created automatically or a notice can be presented requiring the user's confirmation. If confirmed, an agenda event can be created and stored automatically. Of course, persons of ordinary skill in the art would understand that semantic analysis is not restricted to the aforementioned examples, and thus other semantic solution can be used within the spirit of the present invention.

According to one embodiment, a method for intelligent creation of agenda events includes receiving a message, analyzing the received message, determining whether the received message is an agenda-type message based on the data format of the message, and if it is an agenda-type message, creating a new agenda event.

Optionally, the method further includes if the data format analysis indicates that the received message is not an agenda-type message, determining the message type based on a semantic analysis, and if it is an agenda-type message, creating a new agenda event.

Optionally, the data format is predetermined and agreed by the sender and the receiver. The semantic content for analysis may include, by way of example only, time, location, participants, activity or any combination thereof.

Optionally, according to another embodiment of the method for intelligent creation of agenda events, the received message can be determined firstly based on the semantic analysis; if it is determined not as an agenda-type message, the received message type is determined based on the data format of the message.

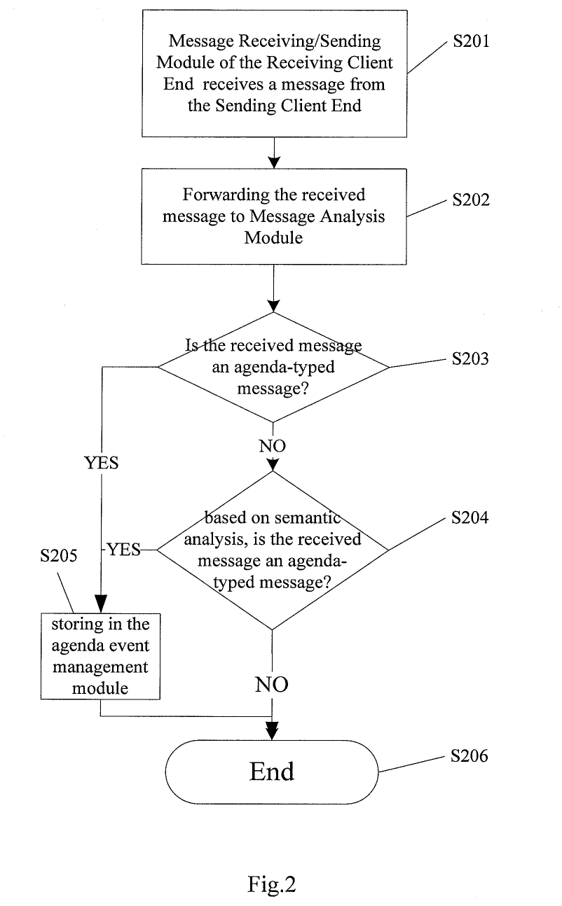

Referring to FIG. 2, a method for intelligent creation of agenda events according to an embodiment is described: At S201, the message receiving/sending module M201 of the receiving client end M200 receives a message from the sending client end M100. At S202, the received message is forwarded to the message analysis module M202. At S203, the message analysis module M202 determines whether the received message is an agenda-type message based on the data format of the received message. If it is determined to be an agenda-type message, the process goes to S205; otherwise, the process goes to S204. At S204, the message analysis module M202 determines whether the received message is an agenda-type message based on a semantic analysis. If it is determined to be an agenda-type message, the process goes to S205; otherwise, the process goes to S206. At S205, the received message is stored in the agenda event management module M203. The process ends at S206.

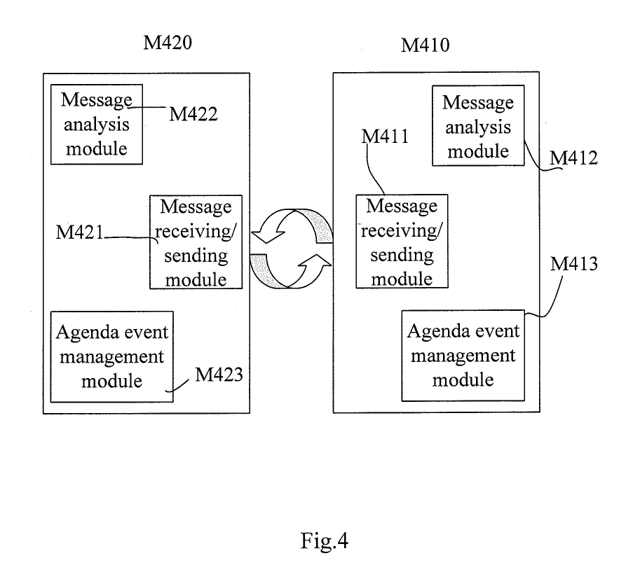

Optionally, according to a further embodiment illustrated in references to FIG. 4, the system for intelligent creation of agenda events can include a first client end M410 and a second client end M420. The first client end M410 can include at least a message sending/receiving module M411, a message analysis module M412, and an agenda event management module M413. The second client end M420 can include at least a message receiving/sending module M421, a message analysis module M422, and an agenda event management module M423. The message receiving/sending module M411 of the first client end can send an agenda-type message to the second client end M420, when the agenda event management module M413 of the first client end creates and stores the agenda event. The agenda event can include, by way of example only, at least the information corresponding to event type, activity, participants, time and location.

The message receiving/sending module M421 of the second client end can receive the message. The message analysis module M422 can analyze the received message. If it is determined as an agenda-type message, the message is forwarded to the agenda event management module M423. The agenda event management module M423 can send notice or inquiry to the user of the second client end M420, for example, “Do you accept the invitation? Yes or No.” Then, the user can choose “accept” or “refuse” and input reason in text format, for example, “I will be in the annual dinner party of my company, can't join you tonight.” If the user chooses to “accept” the agenda-type message, the agenda event management module M425 can create and store the agenda event, then send reasoning or comments to the first client end M410. If the user of the second client end M420 chooses to “refuse” the agenda event, the agenda management module M423 will not create the agenda event and can send reasoning or comments to the first client end M410.

According to this embodiment, the second client end M420 can send an “accept” or “refuse” response and its corresponding reasoning or comments to the first client end M410 through SP interface provided by telecom operators. The sending data format can be a short message, a multimedia message, or a data file.

Subsequently, the message receiving/sending module M411 of the first client end M410 can receive the choice (“accept” or “refuse”) and its corresponding reasoning of the user of the second client end. The message analysis module M412 can analyze and determine whether the message is an agenda-type message and, if positive, forward the message to the agenda event management module M413. The agenda event management module M413 can then update the corresponding information of the agenda event, such as, participants, according to the input of the user of the second client end.

According to an embodiment, when the user of the first client end edits or cancels an established agenda event through the agenda event management module M413, for example, changing the location of the event, the first client end M410 can send a message corresponding to the event change to participants. The participants, such as M420, can receive the message with the message receiving/sending module M421. The message analysis module M422 can then analyze and confirm the agenda-type message, and forward the message to the agenda event management module M423. The user of the second client end M420 can then choose “accept” or “refuse” the event change and input text reasoning. If the user chooses to “accept”, then the agenda event management module can update the change. If the user chooses to “refuse” the event change, a notice can inquire from the user whether to cancel the agenda event. At the same time, the second client end M420 can send the user's choice and corresponding reasoning to the first client end M410.

According to the embodiments, methods and systems for intelligent creation of the agenda events can create agenda events automatically based upon the characteristics of the message. That can greatly improve the efficiency of agenda and has a huge market potential and value.

Although the invention is described above with reference to the embodiments, those skills in the art should understand that the above embodiments are only illustrative, but not limitative. Some features of the above embodiments of the invention can also be used in other embodiments. It is intended that the invention covers all modifications and alternatives defined by the scope of the Claims.

We claim:

1. A method for intelligently creating of agenda events, comprising:
receiving a message;
analyzing the received message;
determining whether the received message is an agenda-type message based on a data format of the received message; and
if the received message is determined as an agenda-type message, creating a first new agenda event.

2. The method of claim 1, wherein the data format of the received message is predetermined and agreed by both a message sender and a message receiver.

3. The method of claim 1, further comprising:
if the received message is determined not as an agenda-type message based on the data format of the received message, determining whether the received message is an agenda-type message based on a semantic analysis; and
if the received message is determined as an agenda-type message, creating a second new agenda event.

4. The method of claim 3, wherein the data format of the received message is predetermined and agreed by both a message sender and a message receiver; and wherein the semantic analysis includes analyzing information of the received message as to time, location, participants, activity, or combinations thereof.

5. A method for intelligently creating of agenda events, comprising:
receiving a message;
analyzing the received message;
determining whether the received message is an agenda-type message based on a semantic analysis; and
if the received message is determined as an agenda-type message, creating a first new agenda event.

6. The method of claim 5, further comprising:
if the received message is determined not as an agenda-type message based on the semantic analysis, determining whether the received message is an agenda-type message based on a data format of the received message; and
if the received message is determined as an agenda-type message, creating a second new agenda event.

7. The method of claim 5 or 6, wherein the data format is predetermined and agreed by both a message sender and a message receiver; and wherein the semantic analysis includes analyzing information of the received message as to time, location, participants, activity, or combinations thereof.

8. A method for intelligently creating of agenda events, comprising:
sending a message by a message sending module of a sending client end to a receiving client end;
receiving the message by a message receiving/sending module of the receiving client end, and forwarding the message to a message analysis module for message analyzing;
if the message is determined as an agenda-type message based on a data format of the message, storing the message in an agenda management module;
if the message is determined not as an agenda-type message, further determining the message based on a semantic analysis; and
if the message is determined as an agenda-type message based on the semantic analysis, storing the message in the agenda management module.

9. A system for intelligently creating of agenda events, comprising a sending client end; and
a receiving client end;
wherein the sending client end includes at least a message sending module;
wherein the receiving client end includes at least a first message receiving/sending module, a first message analysis module, and a first agenda event management module;
wherein the first message receiving/sending module is configured to receive/send messages; the first message analysis module is configured to analyze the received message; and the first agenda event management module is configured to store and process the message if the received message is determined as an agenda-type event.

10. The system of claim 9, wherein the sending client end further comprises a second message receiving module, a second message analysis module, and a second agenda event management module.

11. The system of claim 9 or 10, wherein the sending client end and the receiving client end are communication terminals having communication capabilities.
